(19) United States
(12) Patent Application Publication
(10) Pub. No.: US 2025/0018239 A1
(43) Pub. Date: Jan. 16, 2025

(54) FIREFIGHTING FOAM COMPOSITION

(71) Applicant: Tyco Fire Products LP, Cranston, RI (US)

(72) Inventor: Blake H. Bomann, Greenville, WI (US)

(73) Assignee: Tyco Fire Products LP, Cranston, RI (US)

(21) Appl. No.: 18/712,954

(22) PCT Filed: Jan. 23, 2023
(86) PCT No.: PCT/IB2023/050558

§ 371 Date: May 23, 2024

Related U.S. Application Data
(60) Provisional application No. 63/303,556, filed on Jan. 27, 2022.

(51) Int. Cl. A62D 1/00; A62D 1/02

(52) U.S. Cl. CPC A62D 1/005; A62D 1/0071

(57) ABSTRACT

An aqueous concentrate, which can be diluted with an aqueous diluent to form a foam precursor composition, is provided. The foam precursor composition may be aerated to form a firefighting foam. The present aqueous firefighting composition includes a surfactant component, which includes one or more of an anionic surfactant, a zwitterionic surfactant and a nonionic surfactant; a rheology additive, which includes clay; and at least about 30 wt. % water.

### CROSS-REFERENCE TO RELATED APPLICATIONS

This application claims the benefit of priority to U.S. Provisional Patent Application No. 63/303,556, filed on Jan. 27, 2022, the contents of which are incorporated herein by reference in their entirety.

### BACKGROUND

Firefighting foams are often used to fight Class A and Class B fires. Class A fires are those involving combustible material such as paper, wood, etc. and can be fought by quenching and cooling with large quantities of water or solutions containing water. Class B fires are those involving flammable liquid fuels, gasoline, and other hydrocarbons. Due to the liquid nature of the fuel involved, Class B fires are difficult to extinguish. Most flammable liquids exhibit high vapor pressure along with low fire and flash points. This typically results in a wide flammability range. In this type of fire, the use of water as the sole firefighting agent is generally ineffective because the only means of fighting fire with water is through cooling.

Foaming firefighting agents are better able to combat class B fires, as they function to smother the fire and deprive it of an oxygen source. Conventional foam-forming firefighting compositions may include fluorinated and/or perfluorinated surfactants. Environmental concerns related to fluorinated and perfluorinated materials have developed. As a result, there is a strong desire in the marketplace to replace fluorinated and perfluorinated firefighting products with effective, cost competitive non-fluorinated products. There is therefore a continuing need to produce fluorine-free aqueous film-forming foam (AFFF) firefighting compositions that can be effectively deployed to fight Class B fires.

### SUMMARY

The present application is directed to aqueous foam compositions, typically in concentrate form, which can be diluted with an aqueous diluent to provide a foam precursor composition. The foam precursor composition may subsequently be aerated to provide a firefighting foam.

In one illustrative embodiment, the aqueous firefighting foam composition includes a surfactant component, which comprises an anionic surfactant and a zwitterionic surfactant; polysaccharide thickener; a rheology additive, which includes clay; and at least about 30 wt. % water. Such compositions may be substantially free of any fluorinated surfactant(s). For example, the composition may desirably be substantially free of any fluorinated additive, e.g., contain no more than 0.01 wt. % fluorinated surfactant(s) and, often, is completely free of any fluorinated surfactant or other fluorinated additive.

The present aqueous firefighting compositions may include a surfactant component, which comprises an anionic surfactant and/or a zwitterionic surfactant; polysaccharide thickener; a rheology additive, which includes clay; a sugar component; and at least about 30 wt. % water. Such compositions may be substantially free of any fluorinated additive.

In another illustrative embodiment, the aqueous firefighting foam composition includes polysaccharide thickener; a rheology additive, which includes clay; a sugar component; an aliphatic anionic surfactant; an aliphatic zwitterionic surfactant; nonionic surfactant, which includes C₈₋₁₄-aliphatic alcohol; and at least about 30 wt. % water. Such compositions may be substantially free of any fluorinated additive. These compositions may also include a water-miscible organic solvent. In many instances, the firefighting composition may also include an alkanolamine, e.g., as a pH adjusting agent.

In another illustrative embodiment, the aqueous firefighting foam composition may include polysaccharide thickener; a rheology additive, which includes clay; an aliphatic anionic surfactant; an aliphatic zwitterionic surfactant; polyanionic polymer (e.g., a polysulfonated polymer, such as polyAMPS}; and at least about 30 wt. % water. Such aqueous firefighting compositions may also include an organic solvent, e.g., a water-miscible organic solvent such as an alkylene glycol, glycerol, a water-soluble polyethylene glycol, and/or a glycol ether, and may also contain an aliphatic alcohol-based component. The composition may desirably be substantially free of any fluorinated surfactant(s), e.g., contain no more than 0.01 wt. % fluorinated surfactant(s) and, often, is completely free of any fluorinated surfactant or other fluorinated additive.

Another illustrative embodiment provides an aqueous firefighting foam composition including a sugar component; a polysaccharide thickener; a rheology additive, which includes clay; an anionic surfactant; a nonionic surfactant; a water-miscible solvent; magnesium salt; and at least about 30% water.

Another illustrative embodiment provides an aqueous firefighting foam composition including an anionic surfactant; a zwitterionic surfactant; a water-soluble glycol and/or glycol ether solvent; a rheology additive, which includes clay; a sugar component; at least about 30 wt. % water. Such a composition may desirably be substantially free of any fluorinated surfactant(s), e.g., contain no more than 0.01 wt. % fluorinated surfactant(s) and, often, is completely free of any fluorinated surfactant or other fluorinated additive.

Any of the above embodiments may optionally include other additives to enhance performance of the composition. For example, in any of the above disclosed embodiments, the composition may include one or more of a chelator, a buffer, a corrosion inhibitor, and a preservative. In any of the above embodiments, the composition may have a pH of about 6 to 9. In any of the above embodiments, the composition may be substantially free of cationic surfactants. In any of the above embodiments, the composition may be substantially free of any alkyl polyglycoside surfactant. In any of the above embodiments, the composition may be substantially free of any amine oxide surfactant. In any of the above embodiments, the composition may be substantially free of fluorinated additives.

Another illustrative embodiment provides a method of fighting a fire, including forming a foam from a composition that includes at least one of the aqueous firefighting foam compositions previously disclosed herein, and applying the foam directly or indirectly onto the fire. Such a method may be employed to fight a class A or class B fire.

Another illustrative embodiment provides a method of forming a firefighting foam including diluting the composition of any of the aqueous firefighting foam compositions previously disclosed herein with an aqueous diluting agent to provide a foam precursor solution, and aerating the foam precursor solution to provide the firefighting foam. The aqueous diluting agent may include one or more of municipal water, brackish water and salt water.

### DETAILED DESCRIPTION

The present aqueous firefighting foam compositions include a surfactant component containing (a) one or more of an anionic surfactant, a zwitterionic surfactant and a nonionic surfactant, and (b) a rheology additive, which includes clay, e.g., a smectite-type clay. The aqueous firefighting composition may also include an organic solvent, e.g., a water-miscible organic solvent, a sulfate salt, and/or a polysaccharide thickener. The composition may desirably be substantially free of any fluorinated surfactants or other fluorinated additives. The composition may desirably contain less than 1 ppm F.

The present aqueous firefighting foam compositions typically include an anionic surfactant. The anionic surfactant may suitably include an alkyl sulfate surfactant, an alkyl sulfonate surfactant, alkyl ether sulfate surfactant and/or an alkyl ether sulfonate surfactant. The anionic surfactant typically includes an alkyl sulfate surfactant and/or an alkyl sulfonate surfactant. The alkyl sulfate salt surfactant typically includes include a C₈₋₁₂-alkyl sulfate salt. Suitable examples of the C₈₋₁₂-alkyl sulfate salt include a dodecyl sulfate salt, a decyl sulfate salt, an octyl sulfate salt, or a combination of any two or more thereof. In some embodiments, the alkyl sulfate salt includes an alkyl sulfate sodium salt, such as a sodium decyl sulfate, sodium octyl sulfate, or a combination thereof. In some embodiments, the alkyl sulfate salt includes an alkyl sulfate ammonium salt, such as an ammonium decyl sulfate, ammonium octyl sulfate, ammonium lauryl sulfate, or a combination thereof. One suitable example is the triethanolamine salt of lauryl sulfate. In embodiments that include the anionic surfactant, the aqueous firefighting foam composition may include about 1 to 20 wt. % or about 2 to 15 wt. % of the anionic surfactant. In some embodiments, the aqueous firefighting foam concentrate may include about 5 to 15 wt. %, about 5 to 10 wt. % and, in some instances, about 7 to 8 wt. % of a the anionic surfactant. In some embodiments, the foam composition includes about 7.8 wt. % C₈₋₁₂ alkyl sulfate anionic surfactants.

In some embodiments, the aqueous firefighting foam composition may include an anionic surfactant comprising a C₈₋₁₄-alkyl sulfate salt and/or a C₈₋₁₄-alkyl sulfonate salt. In some embodiments, the aqueous firefighting foam concentrate may include an anionic surfactant, which includes one or more surfactants selected from C₈₋₁₂-alkyl sulfate salts and/or a C₈₋₁₂-alkyl sulfonate salts. For example, one or more of octyl sulfate salts, decyl sulfate salts, dodecyl sulfate salts, and tetradecyl sulfate salts may be suitable for use as anionic surfactants in the present foam concentrate. The anionic surfactant may suitably be a sodium, potassium and/or ammonium salt.

The present aqueous firefighting foam concentrates may include a zwitterionic surfactant. The zwitterionic surfactant typically includes one or more of an aliphatic amidoalkyl betaine surfactant, an alkyl betaine surfactant, an alkyl sulfobetaine surfactant and an aliphatic amidoalkylene hydroxysultaine surfactant, such as an aliphatic amidopropyl hydroxysultaine surfactant. For example, the foam concentrate may include a zwitterionic surfactant, which includes one or more of a C₈₋₁₈-alkylamidopropyl hydroxysultaine surfactant, a C₈₋₁₈-alkylamidopropyl betaine surfactant a C₈₋₁₈-alkyl sulfobetaine surfactant and a C₈₋₁₈-alkyl betaine surfactant. Suitable examples of the aliphatic amidoalkylene hydroxysultaine surfactant include a C₈₋₁₈-alkylamidopropyl hydroxysultaine surfactant, such as a cocamidopropyl hydroxysultaine surfactant, which includes a laurylamidopropyl hydroxysultaine and a myristylamidopropyl hydroxysultaine. Suitable examples of the aliphatic amidoalkyl betaine surfactant include a C₈₋₁₈-alkylamidoalkyl betaine surfactant, such as a cocamidopropyl betaine, a tallowamidopropyl betaine, a laurylamidopropyl betaine, or a myristylamidopropyl betaine. In some embodiments, the zwitterionic surfactant includes a C₈₋₁₄-alkylamidopropyl hydroxysultaine, such as a cocamidopropyl hydroxysultaine. In some embodiments, the zwitterionic surfactant includes laurylamidopropyl hydroxysultaine and/or myristylamidopropyl hydroxysultaine. In embodiments that include the zwitterionic surfactant, the aqueous firefighting foam concentrate may include about 1 to 15 wt. % and often about 1 to 10 wt. % of the zwitterionic surfactant. In certain embodiments, the aqueous firefighting foam concentrate may include about 1 to 6 wt. % or about 2 to 5 wt. % of the zwitterionic surfactant.

In some embodiments, the surfactant component of the composition is limited to an anionic surfactant and a zwitterionic surfactant. In other embodiments, the surfactant component of the composition is limited to an anionic surfactant and a nonionic surfactant. In some embodiments including an anionic surfactant, the anionic surfactant includes one or more of aliphatic sulfate salt, aliphatic sulfonate salt, an aliphatic ether sulfate salt, and aliphatic ether sulfate salt. In other embodiments including an anionic surfactant, the anionic surfactant includes one or more of a C₈₋₁₄-alkyl sulfate salt, a C₈₋₁₄-alkyl ether sulfate salt, and a C₈₋₁₄-alkyl sulfonate salt. In other embodiments including an anionic surfactant, the anionic surfactant includes one or more of an octyl sulfate salt, a decyl sulfate salt, a dodecyl sulfate salt and a tetradecyl sulfate salt. In some embodiments including a zwitterionic surfactant, the zwitterionic surfactant includes one or more of an aliphatic amidoalkyl hydroxysultaine, an aliphatic amidoalkyl betaine, an aliphatic sulfobetaine surfactant, and an aliphatic betaine surfactant. In some embodiments including a zwitterionic surfactant, the zwitterionic surfactant includes a C₈₋₁₄-alkylamidopropyl hydroxysultaine. In some embodiments including a zwitterionic surfactant, the zwitterionic surfactant includes cocamidopropyl hydroxysultaine. In some embodiments including a zwitterionic surfactant, the zwitterionic surfactant includes laurylamidopropyl hydroxysultaine and/or myristylamidopropyl hydroxysultaine. In some embodiments including a nonionic surfactant, the nonionic surfactant includes one or more of an alkyl polyglycoside, an aliphatic alcohol, an ethoxylated aliphatic alcohol, and an aliphatic amine oxide.

In some embodiments including an aliphatic alcohol-based component, the aliphatic alcohol-based component includes one or more C8-14-aliphatic alcohols and/or ethoxylates of C10-14-aliphatic alcohols having an average of no more than about 6 ethylene oxide units. In some embodiments, the composition also includes two or more C₈₋₁₄-aliphatic alcohols, which may be, for example, octyl alcohol and lauryl alcohol. In some embodiments, the composition also includes a water-miscible organic solvent. In some embodiments including a water-miscible organic solvent, the solvent may be one or more of a glycol, glycol ether, glycerol, and/or water-soluble polyethylene glycol (PEG). In some embodiments including a water-miscible organic solvent, the solvent may be one or more of diethylene glycol n-butyl monoether, dipropylene glycol n-propyl monoether, hexylene glycol, ethylene glycol, dipropylene glycol, tripropylene glycol, dipropylene glycol monobutyl ether, dipropylene glycol monomethyl ether, ethylene glycol monobutyl ether, tripropylene glycol monomethyl ether, dipropylene glycol monopropyl ether, propylene glycol, glycerol, or a mixture of two or more thereof. In some embodiments including a water-miscible organic solvent, the solvent may be one or more of ethylene glycol, propylene glycol, and butyl carbitol. In some embodiments, the composition also includes an alkanolamine.

The present aqueous firefighting foam compositions may optionally include a nonionic surfactant. The nonionic surfactant typically includes one or more of an aliphatic alcohol, an ethoxylated aliphatic alcohol, an alkylpolyglycoside surfactant, and an aliphatic amine oxide. Suitable examples of the aliphatic alcohol include C₈₋₁₆ fatty alcohol, either branched or unbranched. In some embodiments, the nonionic surfactant includes lauryl alcohol. Suitable examples of the aliphatic ethoxylated alcohol include ethoxylated C₈₋₁₆ fatty alcohol, either branched or unbranched, with a moderate to low degree of ethoxylation. In compositions including aliphatic alcohol ethoxylates, the ethoxylates may have an average of no more than about 6 and, or no more than about 4 ethylene oxide units, or often no more than about 2 ethylene oxide units. In some embodiments, the nonionic surfactant includes lauryl alcohol ethoxylate (1EO). Suitable examples of the alkylpolyglycoside include a C₈₋₁₆-alkylpolyglycoside having an average degree of polymerization of about 1.0-2.0, or about 1.0-1.5. The alkylpolyglycoside surfactant may suitably include a C₈₋₁₂-alkylpolyglycoside, such as a C₈₋₁₂-alkylpolyglucoside. Suitable examples of the alkylpolyglycoside include a C₉₋₁₁-alkylpolyglucoside, such as a C₉₋₁₁-alkylpolyglucoside having an average degree of polymerization of about 1.4-1.7. The C₉₋₁₁-alkylpolyglucoside may include a nonyl, decyl, an undecyl polyglucoside, or mixtures of any two or more thereof. Other suitable examples of the alkylpolyglycoside include a C₈₋₁₀-alkylpolyglucoside, which may have an average degree of polymerization of about 1.0-1.5. Suitable aliphatic amine oxides include amine oxides including an aliphatic alkyl group containing at least 8 carbon atoms, preferably 10 or more carbon atoms, more preferably 10 to 16 carbon atoms, especially 12 to 14 carbon atoms. The aliphatic group may be a straight chain or a branched chain group, but is preferably a straight chain group. The aliphatic amine oxide may be a mixture of aliphatic amine oxides having different chain lengths. Examples of aliphatic amine oxides that may be used in the present compositions include dodecyl amine oxide and dialkyl alkylamine oxides, such as diethyldecyl amine oxide, dimethyloctyl amine oxide, and dimethyldodecyl amine oxide. Of these, dialkyldodecyl amine oxides (e.g., dimethyllauryl amine oxide) may be used. In embodiments that include the nonionic surfactant, the aqueous firefighting foam composition may suitably include about 0.5 to 10 wt. % of the nonionic surfactant. Typically, the aqueous firefighting foam composition may include about 0.5 to 5 wt. % and, in some instances about 0.5 to 2.5 wt. % of a nonionic surfactant, such as a C₈₋₁₂-alkylpolyglycoside.

The clay included in the rheology additives used in the present compositions may include a phyllosilicate clay, which in some instances may include synthetic and/or organic structural modifications. Examples include aluminium phyllosilicate clays, particularly those of the smectite type. Suitable smectite clays include one or more clays selected from hectorite, montmorillonite, bentonite, beidellite, saponite, and stevensite clays. In some embodiments, the phyllosilicate clay may be modified with an inorganic (e.g., sodium polyphosphate) or organic (e.g., 1-hydroxyethylidene bisphosphonic acid (HEDPA), sodium salt) dispersing agent. In other instances, the phyllosilicate clay may be modified with a quaternary ammonium salt and/or an aliphatic carboxylic acid salt.

In some instances, the clay minerals utilized are particularly those of the smectite family (“smectite-type clays”), including montmorillonite and bentonite clays.

In other instances, the rheology additive may include one or more clay minerals selected from a smectite clay; a hormite clay; illite; vermiculite; and zeolite.

Other suitable rheology additives include synthetic phyllosilicate smectite clays sold under the Laponite® trademark. The group of Laponite® clays are synthetic smectite clays closely resembling the natural clay mineral hectorite. For example, Laponite® RD and Laponite® RDS clays are layered hydrous magnesium silicates that disperse rapidly in water without the need for high shear. Laponite® SL25 is synthetic phyllosilicate modified with a dispersing agent.

The clay used as a rheology additive may include an organically modified clay, e.g., an organically modified montmorillonite clay and/or an organically modified synthetic phyllosilicate smectite clay (e.g., Laponite® EP available from Byk-Chemie, Wesel, Germany). Other examples of suitable organically modified clays includes clays that have been modified with a combination of (a) an organic quaternary ammonium compound and (b) an amine salt of a trimer acid and/or an amine salt of a fatty acid {e.g., a tall oil fatty monocarboxylic acid).

Other examples of suitable organically modified clays includes clays that have been modified with a combination of aliphatic quaternary ammonium salt and alkoxylated quaternary ammonium salt. Such modified clays may be based on a mixture of montmorillonite and sepiolite clays, e.g., mixtures of this type where the majority of the clay is a montmorillonite clay.

Other suitable rheology additives include kaolinite and bentonite clays, which may suitably be used at concentrations in the composition of about 0.1 to 5 wt. %. Bentonite clays consist mostly of montmorillonite, an aluminium phyllosilicate mineral, which takes the form of microscopic platy grains. Kaolinite clays are dioctahedral aluminium phyllosilicate clays.

In some instances, the clay used as a rheology additive may include a hydrated magnesium silicate clay, such as talc. In some instances, the clay used as a rheology additive may include one or more of bentonite clay, kaolinite clay, and talc. In some instances, the clay used as a rheology additive may include one or more of a montmorillonite clay, a hectorite clay, and a saponite clay.

The present aqueous firefighting foam compositions typically include a water-miscible solvent, which may suitably include one or more of a glycol, a glycol ether, glycerol, and a water-soluble polyethylene glycol. Examples of suitable organic solvents include diethylene glycol n-butyl ether, dipropylene glycol n-propyl ether, hexylene glycol, ethylene glycol, propylene glycol, diethylene glycol, dipropylene glycol, tripropylene glycol, dipropylene glycol monobutyl ether, dipropylene glycol monomethyl ether, diethylene glycol monobutyl ether (“butyl carbitol”), ethylene glycol monobutyl ether, tripropylene glycol monomethyl ether, dipropylene glycol monoethyl ether, glycerol, and mixtures of two or more thereof. The organic solvent may include a mixture of an alkylene glycol and a glycol ether, such as a glycol butyl ether. In some embodiments, the organic solvent includes an alkylene glycol ether, such as ethylene glycol monoalkyl ether, propylene glycol monoalkyl ether, dipropylene glycol monoalkyl ether (e.g., and/or diethylene glycol monoalkyl ether (e.g., butyl carbitol). In some embodiments, the organic solvent includes an alkylene glycol, such as ethylene glycol, propylene glycol, dipropylene glycol and/or diethylene glycol. In another suitable example, the organic solvent includes butyl carbitol. The foam composition may suitably include about 1 to 20 wt. %, about 2 to 10 wt. %, about 3 to 8 wt. %, or about 3 to 7 wt. % of the organic solvent.

In one aspect, the present aqueous firefighting foam concentrates include an aliphatic alcohol-based component, such as an aliphatic alcohol and/or an aliphatic alcohol ethoxylate. For example, the concentrate may include an aliphatic alcohol-based component including an aliphatic alcohol having 8 to 14 carbon atoms or an aliphatic alcohol ethoxylate having 10 to 16 carbon atoms in its alcohol portion. Alternatively, the concentrate may include a mixture of an aliphatic alcohol having 8 to 14 carbon atoms and an aliphatic alcohol ethoxylate having 10 to 16 carbon atoms in its alcohol portion. In such mixtures, the ratio of aliphatic alcohol to aliphatic alcohol ethoxylate may be in range of about 10:1 to 1:10, or about 5:1 to 1:5, about 2:1 to 1:2, about 1.5:1 to 1:1:5, or about 1:1. The foam concentrate may suitably include about 0.1 to 5 wt. %, about 0.5 to 3 wt. %, or about 0.5 to 2 wt. % of the aliphatic alcohol-based nonionic surfactant. The aliphatic alcohol ethoxylate may have an average degree of polymerization (i.e., the average number of ethylene oxide units) of about 0.5-6.0 and often of no more than about 4.0, desirably no more than about 3.0 or no more than about 2.0. Aliphatic alcohols, which include a linear C₈₋₁₄-aliphatic alcohol, such as a C₈₋₁₄-fatty alcohol, are suitable for use as a nonionic surfactant in the present concentrates. Suitable examples of such alcohols include one or more of octyl alcohol, decyl alcohol, lauryl alcohol, and myristyl alcohol. The foam concentrate may include an aliphatic alcohol ethoxylate having an average of no more than about 3 ethylene oxide units. The aliphatic alcohol portion of such ethoxylates typically has about 10 to 16 carbon atoms. Suitable examples include decyl alcohol ethoxylates, lauryl alcohol ethoxylates, myristyl alcohol ethoxylates, and/or cetyl alcohol ethoxylates. Such ethoxylates may have an average of no more than about 3 ethylene oxide units, no more than about 2.0 ethylene oxide units, no more than about 1.5 ethylene oxide units and, in some instances, no more than about 1 ethylene oxide units. In one suitable embodiment, the aliphatic alcohol ethoxylate includes an ethoxylate of a linear C₈₋₁₄-aliphatic alcohol having no more than about 1.2 ethylene oxide units.

The aliphatic alcohol-based component may include an aliphatic alcohol ethoxylate. The aliphatic alcohol ethoxylate may have an average degree of polymerization (i.e., the average number of ethylene oxide units) of about 0.5-6.0 and often of no more than about 4.0, desirably no more than about 3.0 or no more than about 2.0. Aliphatic alcohols, which include a linear C₈₋₁₄-aliphatic alcohol, such as a C₈₋₁₄-fatty alcohol, are suitable for use as a nonionic surfactant in the present concentrates. Suitable examples of such alcohols include one or more of octyl alcohol, decyl alcohol, lauryl alcohol, and myristyl alcohol. The foam concentrate may include an aliphatic alcohol ethoxylate having an average of no more than about 3 ethylene oxide units. The aliphatic alcohol portion of such ethoxylates typically has about 10 to 16 carbon atoms. Suitable examples include decyl alcohol ethoxylates, lauryl alcohol ethoxylates, myristyl alcohol ethoxylates, and/or cetyl alcohol ethoxylates. Such ethoxylates may have an average of no more than about 3 ethylene oxide units, no more than about 2.0 ethylene oxide units, no more than about 1.5 ethylene oxide units and, in some instances, no more than about 1 ethylene oxide units. In one suitable embodiment, the aliphatic alcohol ethoxylate includes an ethoxylate of a linear C₈₋₁₄-aliphatic alcohol having no more than about 1.2 ethylene oxide units.

The aqueous firefighting foam composition may include a polysaccharide thickener, such as xanthan gum, welan gum, succinoglycan and/or rhamsan gum. The polysaccharide thickener may include xanthan and a second polysaccharide that is less soluble or insoluble in the aqueous firefighting foam concentrate. In some embodiments, the second polysaccharide may be partially insoluble or insoluble (and dispersed) in the aqueous firefighting concentrate but may be soluble in water alone or in solutions where the concentrate has been diluted with a much larger volume of water. In other embodiments, the concentrate may only include one or more polysaccharides that are completely soluble in the concentrate.

Examples of suitable polysaccharide thickeners, which may be used as the polysaccharide component in the present foam compositions include agar, sodium alginate, carrageenan, gum arabic, gum guaicum, neem gum, pistacia lentiscus, gum chatti, caranna, galactomannan, gum tragacanth, karaya gum, guar gum, welan gum, rhamsam gum, locust bean gum, beta-glucan, cellulose, methylcellulose, chicle gum, kino gum, dammar gum, glucomannan, mastic gum, spruce gum, tara gum, gellan gum, acacia gum, cassia gum, diutan gum, fenugreek gum, ghatti gum, hydroxyethylcellulose, hydroxypropylmethylcellulose, karaya gum, konjac gum, pectin, propylene glycol alginate, and a mixture of two or more thereof.

In some embodiments, the polysaccharide thickener may include one or more of xanthan gum, diutan gum, rhamsan gum, welan, gellan gum, guar gum, succinoglycan, konjac gum, tara gum, and methylcellulose. In some embodiments, it may advantageous to include a mixture of xanthan gum and one or more of diutan gum, rhamsan gum, welan, gellan Gum, guar gum, succinoglycan, konjac gum, tarn gum, and methylcellulose. In other embodiments, the foam concentrate may include a mixture of xanthan gum and one or more of diutan gum, rhamsan gum, welan gum, and gellan gum as the polysaccharide thickener. In other embodiments, the foam concentrate may advantageously include one or more of xanthan gum, succinoglycan, welan gum, diutan gum, and/or rhamsan gum. In other embodiments, the foam concentrate may advantageously include xanthan gum and succinoglycan. In other embodiments, the foam concentrate may advantageously include xanthan gum and diutan gum. In other embodiments, the foam concentrate may advantageously include xanthan gum and rhamsan gum. In other embodiments, the foam concentrate may advantageously include xanthan gum and welan gum. In other embodiments, the foam concentrate may advantageously include welan gum.

Polysaccharide thickeners, which include a combination of xanthan gum and diutan gum, may be particularly suitable for use in the present foam concentrates. For examples, the foam concentrate may include about 0.2 to 3 wt. %, about 0.3 to 2 wt. %, and even, about 0.5 to 1.5 wt. % xanthan gum. Such foam concentrates may also include about 0.1 to 4 wt. %, about 0.5 to 3 wt. % or even, about 0.2 to 2 wt. % diutan gum.

In other instances, polysaccharide thickeners, which include a combination of xanthan gum and succinoglycan, may be particularly suitable for use in the present foam concentrates. In other examples, the foam concentrate may include xanthan gum and about 0.5 to 5 wt. %, about 0.5 to 4 wt. % or even, about 1 to 3 wt. % succinoglycan.

In other instances, polysaccharide thickeners, which include a combination of xanthan gum and welan gum, may be particularly suitable for use in the present foam concentrates. In other examples, the foam concentrate may include xanthan gum and about 0.5 to 5 wt. %, about 0.5 to 4 wt. % or even, about 1 to 3 wt. % welan gum.

Polysaccharide thickeners including a combination of succinoglycan and xanthan gum may be suitable for use in the present foam concentrates. For example, the foam concentrate may include succinoglycan in the amounts already mentioned and about 0.2 to 3 wt. %, about 1.0 to 3 wt. %, and even, about 2 to 2.5 wt. % xanthan gum. Such foam concentrates may also include about 0.1 to 2 wt. %, about 0.5 to 2 wt. % or even, about 0.2 to 1.0 wt. % xanthan gum.

In other instances, polysaccharide thickeners, which include a combination of succinoglycan and welan gum, may be suitable for use in the present foam concentrates. For example, the foam concentrate may include succinoglycan in the amounts already mentioned and about 0.2 to 4 wt. %, about 1.0 to 3 wt. %, and even, about 1 to 2.5 wt. % welan gum. Such foam concentrates may also include and about 0.5 to 5 wt. %, about 0.5 to 4 wt. % or even, about 1 to 3 wt. % welan gum.

In one aspect, the aqueous firefighting foam compositions of the present disclosure include a sugar component, which includes a monosaccharide sugar and/or sugar alcohol. Saccharides for use in the present aqueous fire-fighting foam concentrates are generally simple monosaccharide sugars and may include other carbohydrates, such as common sugar (sucrose/dextrose) derived from sugar cane or sugar beets. Sucrose is a disaccharide composed from the basic, simple sugar molecules glucose, and fructose. Mixtures where the majority of the sucrose has been broken down into its monosaccharide components, glucose and fructose (e.g., invert sugar), are quite suitable for use in the present concentrates. Sucrose is readily available in view of its world production from cane and sugar beet on the order of millions of tons per annum. Those skilled in the art will also be aware that other commercially available simple monosaccharides and related sugar alcohols can be utilized in the present foam concentrates. Examples of suitable monosaccharides for use in the present foam concentrates include one or more of glucose, fructose, mannose, xylose and galactose. Examples of suitable sugar alcohols for use in the present foam concentrates include one or more of a four carbon sugar alcohol, such as erythritol, a five carbon alditol, such as xylitol, a six carbon alditol, such as mannitol and/or sorbitol, and other sugar alcohols, such as isomalt. The sugar alcohol may be derived from a monosaccharide.

The present aqueous fire-fighting foam concentrates may include a sugar component comprising at least about 50 wt. % of one or more monosaccharide sugars and/or sugar alcohols. Suitable examples include a sugar component containing one or more of glucose, fructose, mannose, xylose, sorbitol, xylitol, and mannitol. The foam concentrate may include about 5 to 25 wt. %, or about 10 to 20 wt. % of the sugar component. In some instances, the foam concentrate may include as much as about 45 wt. % or even 50 wt. % of the sugar component. In some embodiments, the sugar component is made up of at least about 75 wt. %, at least about 80 wt. %, or even at least about 90 wt. % monosaccharide sugar and/or sugar alcohol. For example, the sugar component may be made up of at least about 50 wt. %, at least about 75 wt. %, at least about 80 wt. %, or even at least about 90 wt. % of one or more of glucose, fructose, mannose, xylitol, sorbitol, and mannitol. In some embodiments, the foam concentrate may include a sugar component, which is made up of at least about 50 wt. % of one or more sugar alcohols, such as xylitol, sorbitol, and mannitol. Advantageously, the sugar component may include at least about 50 wt. %, at least about 75 wt. %, at least about 80 wt. %, or even at least about 90 wt. % of one or more of glucose, fructose, and sorbitol. For example, the sugar component may include at least about 50 wt. %, or at least about 75 wt. % glucose and/or fructose.

As discussed above, the aqueous firefighting foam composition includes water. In some embodiments, the water may be water from a municipal water source (e.g., tap water). In some embodiments, the water is a purified water, such as purified water that meets the standards set forth in the United States Pharmacopeia, which is incorporated by reference herein in relevant part. In some embodiments, the aqueous firefighting foam composition includes at least about 30 wt. % water, or at least about 40 wt. % water, or at least about 50 wt. % water. In some embodiments, the aqueous firefighting foam concentrate may include greater than about 60 wt. % water. In some embodiments, the aqueous firefighting foam composition may be produced using a source of water that has a total concentration of fluorine atoms on a weight percentage basis of no more than about 1 ppm F.

The aqueous firefighting foam compositions of the present disclosure may be substantially free of any fluorinated additives. As used herein, the “phrase substantially free of fluorinated additives” means that the aqueous firefighting foam composition includes no more than 0.01 wt. % of fluorinated additives. In some embodiments, the aqueous firefighting foam composition includes no more than 0.005 wt. % of fluorinated additives. In some embodiments, the aqueous firefighting foam compositions of the present disclosure may be substantially free of fluorine. As used herein, the phrase “substantially free of fluorine” means that the composition has a total concentration of fluorine atoms on a weight percentage basis of no more than about 1 part per million (ppm) F. The aqueous firefighting foam compositions of the present disclosure preferably include substantially less than 1 ppm F.

In some embodiments, the aqueous firefighting foam composition includes one or more chelators or sequestering buffers. Illustrative and non-limiting chelators and sequestering buffers include agents that sequester and chelate metal ions, including polyamino-polycarboxylic acids, ethylenediaminetetraacetic acid, citric acid, tartaric acid, nitrilotriacetic acid, hydroxyethylethylenediaminetriacetic acid, and salts thereof. Illustrative buffers include Sorensen's phosphate or Mcllvaine's citrate buffers.

In some embodiments, the aqueous firefighting foam composition includes one or more corrosion inhibitors. Illustrative and non-limiting corrosion inhibitors includes ortho-phenylphenol, tolyltriazole, and phosphate ester acids. In some embodiments, the corrosion inhibitor is tolyltriazole.

In some embodiments, the aqueous firefighting foam concentrate may also include a metallic salt, typically a metallic salt, which includes a multi-valent cation. For example, suitable salts may include a cation selected from the group consisting of aluminum, calcium, copper, iron, magnesium, potassium, and calcium cations. The counteranion may suitably be a sulfate and/or phosphate anion. In some embodiments, the composition may optionally contain a divalent metal salt, such as magnesium salt (e.g. magnesium sulfate and/or magnesium acetate). In one embodiment, the metallic salt may include magnesium sulfate.

In some embodiments, the aqueous firefighting foam concentrate may also include a preservative, such as one or more antimicrobial additives and/or biocidal additives. These components are included to prevent the biological decomposition of natural product based polymers that may be incorporated as polymeric film formers (e.g., a polysaccharide gum). Examples of suitable antimicrobial/biocidal additives include Kathon CG/ICP (Rohm & Haas Company), Givgard G-4 40 (Givaudan, Inc.), Dowicil 75, and Dowacide A (Dow Chemical Company).

Tables A-E provide illustrative examples of firefighting compositions that are suitable under the present disclosure. The compositions are designed to be combined with a diluent, aerated, and administered to as a firefighting foam fight and/or suppress a fire.

TABLE A
Illustrative Concentrate Formulation

| Ingredient | Amount (Wt. %) |
|---|---|
| Biocide | 0-0.2 |
| Corrosion Inhibitor | 0-0.2 |
| Water | 30-85 |
| Zwitterionic Surfactant | 1-15 |
| Anionic Surfactant | 2-20 |
| Clay rheology additive | 0.1-10 |
| Water-miscible organic solvent | 1-20 |
| Monosaccharide sugar(s) and/or sugar | 0-30 |
| alcohol(s) | |
| Alkanolamine | 0-5 |

TABLE B
Illustrative Concentrate Formulation

| | Amount |
|---|---|
| Ingredient | (Wt. %) |
| Biocide | 0-0.2 |
| Corrosion Inhibitor | 0-0.2 |
| Water | 40-75 |
| Hydroxysultaine Zwitterionic Surfactant | 1-10 |
| Alkyl Sulfate Anionic Surfactant | 5-15 |
| Polysaccharide Gum | 0.2-4 |
| Clay rheology additive | 0.1-10 |
| Glycol Ether Solvent | 2-15 |
| Polyol Solvent | 0-10 |
| Monosaccharide sugar(s) and/or | 5-25 |
| sugar alcohol(s) | |
| Clay rheology additive | 0.1-10 |
| Alkanolamine | 0-5 |

TABLE C
Illustrative Concentrate Formulation

| | Amount |
|---|---|
| Ingredient | (Wt. %) |
| Tolytriazole (corrosion inhibitor) | 0~0.1 |
| Antimicrobial | 0~0.1 |
| Alkyl hydroxysultaine surfactant | 1-8 |
| Alkyl sulfate surfactant | 1~5 |
| Fatty alcohol surfactant | 0.5-2 |
| Clay rheology additive | 0.1-10 |
| Polysaccharide gum thickener | 1~3 |
| Polyanionic polymer | 0-3 |
| Butyl carbitol | 1-10 |
| Alkylene glycol solvent | 2-10 |
| Monosaccharide sugar(s) | 5-20 |
| Water | Balance |

TABLE D
Illustrative Concentrate Formulation

| | Amount |
|---|---|
| Ingredient | (Wt. %) |
| Tolytriazole (corrosion inhibitor) | 0~0.1 |
| Antimicrobial | 0~0.1 |
| Alkyl sulfo-betaine surfactant | 1-5 |
| Alkyl sulfate surfactant | 1~5 |
| Polysaccharide gum thickener | 0.2-4 |
| Clay rheology additive | 0.1-10 |
| Alkylene glycol ether solvent | 0-10 |
| Alkylene glycol solvent | 0-10 |
| Water | Balance |

TABLE E
Illustrative Concentrate Formulation

| Ingredient | Amount (Wt. %) |
|---|---|
| Tolytriazole (corrosion inhibitor) | 0~0.1 |
| Antimicrobial | 0~0.1 |
| Alkyl sulfo-betaine surfactant | 1-5 |
| Alkyl sulfate surfactant | 1~5 |
| Alkyl polysaccharide surfactant | 2-6 |
| Polysaccharide gum thickener | 0.2-4 |
| Clay rheology additive | 0.1-10 |
| Magnesium sulfate | 0.5~3 |
| Alkylene glycol ether solvent | 0-10 |
| Alkylene glycol solvent | 0-10 |
| Water | Balance |

The present aqueous firefighting compositions may advantageously be substantially free of any fluorinated additives. As used herein, the “phrase substantially free of fluorinated additives” means that the aqueous firefighting composition contains a total of no more than 0.1 wt. % fluorinated additives. In some embodiments, the aqueous firefighting composition contains a total of no more than 0.01 wt. % and, in some instances, a total of no more than 0.005 wt. % fluorinated additives. The aqueous firefighting compositions of the present disclosure may be substantially free of fluorine in any form. As used herein, the phrase “substantially free of fluorine” means that the aqueous firefighting composition has no intentionally added fluorine and, in some instances, may have a total concentration of fluorine atoms on a weight percentage basis of no more than about 1 ppm F.

### ILLUSTRATIVE EXAMPLES

The following examples more specifically illustrate formulations for preparing aqueous firefighting compositions according to various embodiments described herein. These examples should in no way be construed as limiting the scope of the present technology.

### Example A

Tables 1 and 2 below show the compositions of a number of illustrative formulations of the present aqueous firefighting foam concentrate. The amounts shown in these tables represent the weight percentage of the particular component based on the total weight of the composition.

TABLE 1
Illustrative Examples

| | Ex. 1 | Ex. 2 | Ex. 3 | Ex. 4 | Ex. 5 | Ex. 6 |
|---|---|---|---|---|---|---|
| Water | Balance | Balance | Balance | Balance | Balance | Balance |
| | (74.8) | (74.8) | (75.3) | (74.9) | (52.6) | (33.2) |
| Butyl Carbitol | 7 | 7 | 7 | 7 | 5 | 5 |
| 1,3-Propandiol | — | — | — | — | — | 2 |
| Ethylene glycol | 3 | 3 | 3 | 3 | 2 | — |
| TEA Lauryl sulfate | 3.4 | 3.4 | 3.4 | 3.4 | 3.4 | 3.4 |
| Na Decyl sulfate | 1.6 | 1.6 | 0.8 | 1.4 | 1.2 | 1.6 |
| Na Octyl sulfate | 3.2 | 3.2 | 3.2 | 3.3 | 3.3 | 3.2 |
| Hydroxy Sultaine* | 3.4 | 3.4 | 3.4 | 3.4 | 3.4 | 3.4 |
| High Fructose CS | 14.2 | 14.2 | 14.2 | 14.2 | 17.8 | 45.7 |
| Sol-forming clay | — | — | — | — | 9.8 | — |
| Gel-forming clay | 0.9 | 0.9 | 1.2 | 0.9 | — | 1.0 |
| Xanthan gum | 0.75 | — | — | — | — | 0.75 |
| Diutan gum | 0.75 | 1.5 | 1.5 | 1.5 | 1.5 | 0.75 |

| | Ex. 7 | Ex. 8 | Ex. 9 | Ex. 10 |
|---|---|---|---|---|
| Water | Balance | Balance | Balance | Balance |
| | (~52) | (~52) | (~52) | (~55) |
| Butyl Carbitol | 7 | 7 | 6.5 | 6.5 |
| Ethylene glycol | — | — | — | — |
| Hexylene glycol | 4 | 4 | 4 | 4 |
| TEA Lauryl sulfate | 9.0 | 4.2 | 4.2 | 4.2 |
| 1-Octanol | — | — | 0.25 | 0.25 |
| 1-Dodecanol | — | — | 0.25 | 0.25 |
| Hydroxy Sultaine* | 4.3 | 9.2 | 9.2 | 9.2 |
| PolyAMPS | — | 0.8 | 0.8 | 0.8 |
| High Fructose CS | 14.2 | 14.2 | 14.2 | 14.2 |
| TEA | 1.0 | 1.0 | 1.0 | 1.0 |
| Sol-forming modified | 7.0 | 6.0 | 6.0 | 3.0 |
| clay | | | | |
| Xanthan gum | 1.5 | 1.5 | 1.5 | 1.5 |

*Cocamidopropyl Hydroxy Sultaine

TABLE 2
Illustrative Examples

| | Ex. 11 | Ex. 12 | Ex. 13 | Ex. 14 | Ex. 15 |
|---|---|---|---|---|---|
| Water | Balance | Balance | Balance | Balance | Balance |
| | (~51) | (~51) | (~56) | (~59) | (~52) |
| Butyl Carbitol | 7 | 7 | 7 | 7 | 9 |
| Ethylene glycol | 4 | 4 | 4 | 4 | 4 |
| TEA Lauryl Sulfate | 4.2 | 9.0 | 9.0 | 9.0 | 9.0 |
| Hydroxy Sultaine* | 9.2 | 4.3 | 4.3 | 4.3 | 4.3 |
| High Fructose CS | 14.2 | 14.2 | 14.2 | 14.2 | 14.2 |
| TEA | 1.0 | 1.0 | 1.0 | 1.0 | 1.0 |
| Sol-forming clay | 9.1 | 9.1 | 4.6 | — | — |
| Gel-forming clay | — | — | — | 1.1 | 1.46 |

Tables 3 and 4 below list a number of properties relating to viscosity and fire control characteristics for certain of the examples listed in Tables 1 and 2 above.

TABLE 3
Properties of Illustrative Examples

| | Ex. 6 | Ex. 7 | Ex. 8 | Ex. 9 | Ex. 10 |
|---|---|---|---|---|---|
| Initial viscosity | | 860 | 1120 | 1180 | |
| 3% 3GPM/salt* | | | | | |
| 90% Fire Control (sec) | | 74 | 71 | 72 | 65 |
| Extinguish (sec) | | | 237 | 189 | 168 |
| Flashover (sec) | | | | 40 | 165 |
| 25% Burnback (sec) | 300 | | | 300 | 480 |
| Expansion Ratio | | 5.13 | 3.43 | 3.98 | 6.36 |
| 25% Drain Time (sec) | | 574 | 1206 | 847 | 1091 |

*3 gallons/minute flow (“forceful”) of a solution of 3% foam concentrate in salt water on a heptane fire

TABLE 4
Properties of Illustrative Examples

| | Ex. 11 | Ex. 12 | Ex. 13 | Ex. 14 | Ex. 15 |
|---|---|---|---|---|---|
| Initial viscosity | | | | 820 | 1160 |
| 3% 3 GPM/salt** | | | | | |
| 90% Fire Control (sec) | 75 | 74 | 53 | | |
| Extinguish Time (sec) | 291 | 282 | 270 | | |
| Flashover (sec) | | 773 | | | |
| 25% Burnback (sec) | | 848 | 564 | | |
| Expansion Ratio | | 4.3 | 7.73 | | |
| 25% Drain Time (sec) | | <120 | 82 | | |
| 1% 3 GPM/fresh*** | | | | | |
| 90% Fire Control (sec) | | 72 | | | 67 |
| Extinguish (sec) | | 141 | | | 129 |
| 25% Burnback (sec) | | 570 | | | 684 |
| Expansion Ratio | | 9.1 | | | 6.1 |
| 25% Drain Time (sec) | | <180 | | | 409 |

**3 gallons/minute flow (“gentle”) of a solution of 3% foam concentrate in salt water on a heptane fire
***1 gallons/minute flow (“gentle”) of a solution of 3% foam concentrate in fresh water on a heptane fire

### Method of Producing a Firefighting Foam

The firefighting foam compositions described herein may be mixed with a diluent to form firefighting foam precursor solution, i.e., a use strength composition. The firefighting foam precursor solution may be aerated (e.g., using a nozzle) to produce a firefighting foam including the firefighting foam concentrate and the diluent. Typically, the concentrate is mixed into a flowing stream of the diluent, e.g., the concentrate is introduced through the use of an eductor into a stream of the diluent flowing through a hose or pipe. Illustrative diluents may include water, such as fresh water, brackish water, sea water, and combinations thereof. In some embodiments, the firefighting foam compositions described above may be 1 vol. %, 3 vol. %, or 5 vol. % concentrate solutions, meaning that the firefighting foam compositions are mixed with 99 vol. %, 97 vol. %, or 95 vol. % diluent, respectively, to form the firefighting foam precursor solution.

In some instances, it has been found that the order of addition of ingredients with appropriate agitation in producing the present concentrates may impact the actual firefighting performance as seen in the UL and EN fire tests. It may be suitable to begin by mixing all or a portion of a water-miscible solvent component with a substantial amount of water and subsequently preparing a solution or slurry of the polysaccharide thickener in the resulting aqueous solution prior to blending in the remaining components of the foam concentrate. It was found that first preparing an aqueous solution by combining and mixing water-miscible solvent with water may facilitate later dissolution and/or dispersal of biogums/biopolymers (e.g., xanthan gum). This can allow the gums to properly hydrate without encapsulating (clumping) upon the addition of the surfactant(s), other optional additives, and remaining amounts of water. Surfactants and other optional additives can then be added and the resulting mixture may finally be diluted further with water to decrease the viscosity of the preparation, if desired.

Firefighting foams that were prepared not following this order of component addition may result in polysaccharide biogums that are encapsulated, but not fully hydrated, which can result in the production of foams that exhibit less than satisfactory for fire suppression performance. Thus, in some embodiments, the initial formation of an aqueous solution containing water-miscible solvent can be important in process order and can be used to dissolve/disperse polysaccharide thickener(s) into the foam concentrate before addition of any other ingredients, such as surfactant(s) and/or other additives.

### Method of Fighting a Fire

The firefighting foam compositions described herein may be used to fight a fire and/or to suppress flammable vapors by mixing the firefighting foam compositions with a diluent, aerating the resulting firefighting foam precursor solution to form a firefighting foam, and administering the firefighting foam to a fire or applying the firefighting foam to the surface of a volatile flammable liquid (e.g., gasoline or other flammable hydrocarbon or a flammable polar solvent).

### Illustrative Embodiments

Reference is made to a number of illustrative embodiments of the subject matter described herein. The following embodiments describe illustrative embodiments that may include various features, characteristics, and advantages of the subject matter as presently described. Accordingly, the following embodiments should not be considered as being comprehensive of all of the possible embodiments or otherwise limit the scope of the methods, materials, and compositions described herein.

The present application is directed to aqueous foam compositions in concentrate form, which can be diluted with an aqueous diluent to provide a foam precursor composition, which may be aerated to form a firefighting foam. A first illustrative embodiment provides an aqueous firefighting compositions including a sugar component; a surfactant component containing one or more of a nonionic surfactant, an anionic surfactant, and a zwitterionic surfactant; a polysaccharide thickener; and a rheology additive, which includes clay. Such a composition may also include one or more of an alkanolamine, a glycol solvent, a glycol ether solvent, an aliphatic alcohol-based component and a magnesium salt. In some embodiments, the sugar component is made up of at least about 50 wt. % of a monosaccharide or sugar alcohol. The aqueous firefighting compositions disclosed herein may also include an organic solvent, e.g., a water-miscible organic solvent such as an alkylene glycol, glycerol, a water-soluble polyethylene glycol, and/or a glycol ether, and may also contain an aliphatic alcohol-based component.

The composition may contain one or more polysaccharide thickeners, such as a natural gum. For example, the polysaccharide thickener may include xanthan gum, diutan gum, rhamsan gum, welan gum, gellan gum, guar gum, konjac gum, tara gum, and methylcellulose. In some embodiments, the polysaccharide thickener includes one or more of agar, sodium alginate, carrageenan, gum arabic, gum guaicum, neem gum, pistacia lentiscus, gum chatti, caranna, galactomannan, gum tragacanth, karaya gum, guar gum, xanthan gum, welan gum, rhamsam gum, locust bean gum, beta-glucan, cellulose, methylcellulose, chicle gum, kino gum, dammar gum, glucomannan, mastic gum, spruce gum, tara gum, gellan gum, acacia gum, cassia gum, diutan gum, fenugreek gum, ghatti gum, hydroxyethylcellulose, hydroxypropylmethyl-cellulose, karaya gum, konjac gum, pectin, and propylene glycol alginate. The composition may desirably be substantially free of any fluorinated surfactant(s), e.g., contain no more than 0.01 wt. % fluorinated surfactant(s) and, often, is completely free of any fluorinated surfactant or other fluorinated additive.

In some embodiments, the surfactant component includes an anionic surfactant and a zwitterionic surfactant. In other embodiments, the surfactant component of the composition includes an anionic surfactant and a nonionic surfactant. In some embodiments including an anionic surfactant, the anionic surfactant includes one or more of aliphatic sulfate salt, aliphatic sulfonate salt, an aliphatic ether sulfate salt, and aliphatic ether sulfate salt. In other embodiments including an anionic surfactant, the anionic surfactant includes one or more of a C₈₋₁₄-alkyl sulfate salt, a C₈₋₁₄-alkyl ether sulfate salt, and a C₈₋₁₄-alkyl sulfonate salt. In other embodiments including an anionic surfactant, the anionic surfactant includes one or more of an octyl sulfate salt, a decyl sulfate salt, a dodecyl sulfate salt, and a tetradecyl sulfate salt. In some embodiments including a zwitterionic surfactant, the zwitterionic surfactant includes one or more of an aliphatic amidoalkyl hydroxysultaine, an aliphatic amidoalkyl betaine, an aliphatic sulfobetaine surfactant, and an aliphatic betaine surfactant. In some embodiments including a zwitterionic surfactant, the zwitterionic surfactant includes a C₈₋₁₄-alkylamidopropyl hydroxysultaine. In some embodiments including a zwitterionic surfactant, the zwitterionic surfactant includes cocamidopropyl hydroxysultaine. In some embodiments including a zwitterionic surfactant, the zwitterionic surfactant includes laurylamidopropyl hydroxysultaine and/or myristylamidopropyl hydroxysultaine. In some embodiments including a nonionic surfactant, the nonionic surfactant includes one or more of an alkyl polyglycoside, an aliphatic alcohol, an ethoxylated aliphatic alcohol, and an aliphatic amine oxide.

In some embodiments the composition may include an aliphatic alcohol-based component, the aliphatic alcohol-based component includes one or more C8-14-aliphatic alcohols and/or ethoxylates of C10-14-aliphatic alcohols having an average of no more than about 6 ethylene oxide units. In some embodiments, the composition also includes two or more C₈₋₁₄-aliphatic alcohols, which may be, for example, octyl alcohol and lauryl alcohol.

In some embodiments, the composition may include a water-miscible organic solvent. In some embodiments including a water-miscible organic solvent, the solvent may be one or more of a glycol, glycol ether, glycerol, and/or water-soluble polyethylene glycol (PEG). In some embodiments including a water-miscible organic solvent, the solvent may be one or more of diethylene glycol n-butyl monoether, dipropylene glycol n-propyl monoether, hexylene glycol, ethylene glycol, dipropylene glycol, tripropylene glycol, dipropylene glycol monobutyl ether, dipropylene glycol monomethyl ether, ethylene glycol monobutyl ether, tripropylene glycol monomethyl ether, dipropylene glycol monopropyl ether, propylene glycol, glycerol, or a mixture of two or more thereof. In some embodiments including a water-miscible organic solvent, the solvent may be one or more of ethylene glycol, propylene glycol, and butyl carbitol. In some embodiments, the composition also includes an alkanolamine.

In some embodiments, the aqueous firefighting foam composition includes about 5 to 25 wt. % of the sugar component; about 0.1 to 5 wt. % of an aliphatic alcohol-based nonionic surfactant; about 2 to 15 wt. % of the anionic surfactant; about 2 to 10 wt. % of the zwitterionic surfactant; about 2 to 15 wt. % of the water-miscible organic solvent; about 1 to 5 wt. % of the polysaccharide thickener; about 0.5 to 10 wt. % of the clay; and at least about 40 wt. % water; wherein the composition contains no more than 0.01 wt. % fluorinated surfactants.

In some embodiments, the aqueous firefighting composition may include about 5 to 20 wt. % monosaccharide sugar; about 3 to 10 wt. % C8-14-alkyl sulfate anionic surfactant; about 2 to 8 wt. % C8-14-alkylamidopropyl hydroxysultaine; about 0.2 to 2 wt. % C8-14-aliphatic alcohol; about 0.5 to 10 wt. % of the clay; about 0.5 to 3 wt. % of the polysaccharide thickener; about 2 to 10 wt. % butyl carbitol; and at least about 40 wt. % water; wherein the composition contains no more than 0.01 wt. % fluorinated surfactants.

In other embodiments, the aqueous firefighting composition may include: a surfactant component comprising one or more of an anionic surfactant and a zwitterionic surfactant; an C₈₋₁₄-aliphatic alcohol-based component; polysaccharide thickener; a rheology additive, which includes clay; and at least about 40 wt. % water; wherein the composition is substantially free of any fluorinated additives.

In other embodiments, the aqueous firefighting composition may include: a sugar component; polysaccharide thickener; a rheology additive, which includes clay; anionic surfactant; nonionic surfactant; water-miscible organic solvent; and at least about 30 wt. % water; wherein the composition is substantially free of any fluorinated additives.

In other embodiments, the aqueous firefighting composition may include: an aliphatic sulfate anionic surfactant; an aliphatic hydroxysultaine and/or betaine zwitterionic surfactant; a water-soluble glycol and/or glycol ether solvent; a rheology additive, which includes clay {e.g., a smectite-type clay}; monosaccharide sugar; at least about 30 wt. % water; wherein the composition is substantially free of any fluorinated additives.

Another illustrative embodiment provides an aqueous firefighting foam composition including a surfactant component, which comprises an anionic surfactant and a zwitterionic surfactant; polysaccharide thickener; a rheology additive, which includes clay; and at least about 30 wt. % water. Such compositions may be substantially free of any fluorinated surfactant(s). For example, the composition may desirably be substantially free of any fluorinated additive, e.g., contain no more than 0.01 wt. % fluorinated surfactant(s) and, often, is completely free of any fluorinated surfactant or other fluorinated additive.

Another illustrative embodiment provides a method of fighting a fire, including forming a foam from a composition that includes at least one of the aqueous firefighting foam compositions previously disclosed herein, and applying the foam directly or indirectly onto the fire. Such a method may be employed to fight a class A or class B fire.

Another illustrative embodiment provides a method of forming a firefighting foam including diluting the composition of any of the aqueous firefighting foam compositions previously disclosed herein with an aqueous diluting agent to provide a foam precursor solution, and aerating the foam precursor solution to provide the firefighting foam. The aqueous diluting agent may include one or more of municipal water, brackish water and salt water.

While certain embodiments have been illustrated and described, it should be understood that changes and modifications can be made therein in accordance with ordinary skill in the art without departing from the technology in its broader aspects.

The embodiments illustratively described herein may suitably be practiced in the absence of any element or elements, limitation or limitations, not specifically disclosed herein. Thus, for example, the terms “comprising,” “including,” “containing,” shall be read expansively and without limitation. Additionally, the terms and expressions employed herein have been used as terms of description and not of limitation, and there is no intention in the use of such terms and expression of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “and” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or illustrative language (e.g., “such as”) provided herein, is intended merely to better illuminate the embodiments and does not pose a limitation on the scope of the claims unless otherwise stated. No language in the specification should be construed as indicating any non-claimed element as essential.

Additionally, where features or aspects of the disclosure are described in terms of Markush groups, those skilled in the art will realize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof.

1. An aqueous firefighting composition comprising:
a surfactant component comprising an anionic surfactant and a zwitterionic surfactant;
a polysaccharide thickener;
a rheology additive comprising a clay; and
at least about 30 wt. % water;
wherein: the composition is substantially free of fluorinated additive.

2. (canceled)

3. The composition of claim 1, wherein the firefighting composition further comprises a sugar component.

4-12. (canceled)

13. The composition of claim 1, wherein the firefighting composition further comprises a polyanionic polymer.

14-15. (canceled)

16. The composition of claim 1, wherein the clay comprises a smectite-type clay.

17. The composition of claim 1, wherein the clay comprises an organically modified clay.

18. The composition of claim 1, wherein the clay comprises a synthetic smectite clay.

19. The composition of claim 1, wherein the clay comprises a phyllosilicate clay.

20. (canceled)

21. The composition of claim 1, wherein the clay comprises one or more of bentonite clay, kaolinite clay, and talc.

22. The composition of claim 1, wherein the clay comprises an organically modified synthetic phyllosilicate clay.

23. The composition of claim 1, wherein the clay comprises a hydrated magnesium silicate clay.

24. The composition of claim 1, wherein the clay comprises one or more of a hectorite, montmorillonite, bentonite, beidellite, saponite and stevensite clay.

25-35. (canceled)

36. The composition of claim 1, wherein the composition comprises a nonionic surfactant comprising one or more of an alkyl polyglycoside, an aliphatic alcohol, an ethoxylated aliphatic alcohol, and an aliphatic amine oxide.

37-39. (canceled)

40. The composition of claim 1, wherein the composition further comprises a water-miscible organic solvent.

41-66. (canceled)

67. The composition of claim 1, wherein the composition is substantially free of any cationic surfactant.

68. The composition of claim 1, wherein the composition is substantially free of any alkyl polyglycoside surfactant.

69. The composition of claim 1, wherein the composition is substantially free of any amine oxide surfactant.

70. The composition of claim 1, wherein the composition is substantially free of any silicone surfactant.

71. The composition of claim 1, wherein the composition is substantially free of any hydrophobic additives, such as mineral oil, vegetable oil, or paraffin material.

72. The composition of claim 1, wherein the composition is substantially free of any protein or amino acid based additives.

73. A method of fighting a fire, comprising forming a foam comprising the aqueous firefighting composition of claim 1, and applying the foam directly or indirectly onto the fire.

74-77. (canceled)
